(19) United States
(12) Patent Application Publication
(10) Pub. No.: US 2026/0304008 A1
(43) Pub. Date: Oct. 1, 2026

(54) IMAGING DEVICE

(71) Applicant: SONY SEMICONDUCTOR SOLUTIONS CORPORATION, KANAGAWA (JP)

(72) Inventor: YUSAKU SUGIMORI, KANAGAWA (JP)

(21) Appl. No.: 19/489,410

(22) PCT Filed: Jun. 12, 2024
(86) PCT No.: PCT/JP2024/021283

§ 371 Date: Dec. 2, 2025

(30) Foreign Application Priority Data
Jun. 28, 2023 (JP) 2023-106472

(51) Int. Cl. H04N 25/78; H04N 23/71; H04N 25/65; H04N 25/778

(52) U.S. Cl. CPC H04N 25/78; H04N 23/71; H04N 25/65; H04N 25/778

(57) ABSTRACT

To reduce power consumption and shorten settling time of a vertical signal line by making a reset potential of a vertical signal line variable.

An imaging device includes a plurality of pixels arranged in one direction and each including a photoelectric conversion element, a signal line that transmits a plurality of pixel signals obtained as a result of photoelectric conversion in the plurality of pixels, an illuminance determination unit that determines illuminance of light incident on the plurality of pixels, and a reset potential switch that switches a reset potential for initializing a potential of the signal line on a basis of the illuminance determined by the illuminance determination unit.

### TECHNICAL FIELD

The present disclosure relates to an imaging device.

### BACKGROUND ART

In a normal CMOS image sensor (a CIS hereinafter), a vertical signal line is provided for each of pixel columns arranged in a vertical (longitudinal) direction, and each vertical signal line transmits a pixel signal output from each pixel of a corresponding pixel column. Time required for a potential of the vertical signal line to stabilize is called settling time. In a conventional CIS, a constant current load may be used to shorten settling time of a vertical signal line. With the constant current load, a current continues to flow from a power supply voltage to a ground node through a vertical signal line, and there is a problem that power consumption is large.

On the other hand, Patent Document 1 discloses a technique of causing a current to flow from a power supply voltage node connected to a drain of an amplifier transistor in a pixel to a vertical signal line through the amplifier transistor to accumulate charge in a capacitor connected to the vertical signal line. In Patent Document 1, charge according to a potential difference obtained by subtracting a threshold voltage of the amplifier transistor from a potential (an FD potential hereinafter) of a floating diffusion can be accumulated in the capacitor, and no current flows from the amplifier transistor to the vertical signal line after the accumulation in the capacitor, so that power saving can be achieved.

### CITATION LIST

### Patent Document

Patent Document 1: Japanese Patent Application Laid-Open No. 2021-40270

### SUMMARY OF THE INVENTION

### Problems to be Solved by the Invention

In the circuit configuration of Patent Document 1, since a current continues to flow from the amplifier transistor to the vertical signal line until the charge according to the potential difference described above is accumulated in the capacitor, there is a problem that a minute current flows even in a state where the amplifier transistor is about to be turned off, and the settling time of the vertical signal line becomes long.

Furthermore, in the circuit configuration of Patent Document 1, when the FD potential rises, the potential of the vertical signal line can be raised following the FD potential, but when the FD potential drops, the potential of the vertical signal line cannot be lowered following the FD potential.

Therefore, in the circuit configuration of Patent Document 1, it is necessary to forcibly lower the potential of the vertical signal line to a reset potential. For example, in a case where high illuminance light is incident on the pixel, a potential of a pixel signal is low, and it does not take much time to cause the vertical signal line to transition from the reset potential to the potential of the pixel signal, but in a case where low illuminance light is incident on the pixel, a potential difference between the reset potential of the vertical signal line and the potential of the pixel signal is large, and it takes time to stabilize the potential of the vertical signal line, and power consumption also increases.

Therefore, the present disclosure provides an imaging device capable of reducing power consumption and shortening settling time of a vertical signal line by making a reset potential of the vertical signal line variable.

### Solutions to Problems

In order to solve the above problem, the present disclosure provides an imaging device including
a plurality of pixels arranged in one direction and each including a photoelectric conversion element,
a signal line that transmits a plurality of pixel signals obtained as a result of photoelectric conversion in the plurality of pixels,
an illuminance determination unit that determines illuminance of light incident on the plurality of pixels, and
a reset potential switch that switches a reset potential for initializing a potential of the signal line on the basis of the illuminance determined by the illuminance determination unit.

The illuminance determination unit may determine the illuminance in at least two stages.

The illuminance determination unit may determine high illuminance or low illuminance, and
the reset potential switch may set the reset potential higher in a case where low illuminance is determined than in a case where high illuminance is determined.

The reset potential switch may set the reset potential in a case where the signal line has a noise potential to be higher than the reset potential in a case where the illuminance determination unit determines low illuminance.

The imaging device may further include:
a pixel array unit including the plurality of pixels arranged in a first direction and a second direction; and
a plurality of the signal lines, each of which extends in the second direction, is arranged in the first direction, and transmits two or more pixel signals obtained as a result of photoelectric conversion by two or more of the pixels arranged in the second direction, in which
the illuminance determination unit and the reset potential switch are provided for each of the plurality of signal lines.

The reset potential switch may select, as the reset potential, one of a plurality of input potentials having different potential levels.

The plurality of input potentials may include at least three types of input potentials for setting a noise potential, a reset potential for low illuminance, or a reset potential for high illuminance to the signal line.

Each of the plurality of pixels may include a transfer transistor and a floating diffusion, and
before transfer of charge by photoelectric conversion from the photoelectric conversion element to the floating diffusion via the transfer transistor is started, the illuminance determination unit may determine the illuminance on the basis of a charge leaking from the photoelectric conversion element to the floating diffusion.

The illuminance determination unit may determine the illuminance on the basis of signal potentials of the pixel signals according to an amount of light incident on the plurality of pixels.

The plurality of pixels may be capable of switching photoelectric conversion efficiency in at least two stages, and
the illuminance determination unit may determine the illuminance on a basis of the signal potentials of the pixel signals in a state where the photoelectric conversion efficiency is maximum.

The imaging device may further include:
a signal processing unit that performs signal processing including generation of a digital signal according to the potential of the signal line on the basis of a result of comparison between the potential of the signal line and a reference signal, in which
in a case where the signal line has a noise potential, the reset potential switch may set the reset potential according to the noise potential to the signal line, and then set the reset potential according to the illuminance determined by the illuminance determination unit to the signal line.

Each of the plurality of pixels may include a plurality of the photoelectric conversion elements having different sensitivities, and
the reset potential switch may set the reset potential according to a noise potential to the signal line and read the noise potential after the illuminance determination unit determines the illuminance, and then sequentially set the reset potential according to the illuminance determined by the illuminance determination unit to the signal line and reads signal potentials for each of the plurality of photoelectric conversion elements.

The imaging device may further include:
a reference signal generation circuit that generates a reference signal for setting the signal line to a reference potential, in which
the illuminance determination unit may determine the illuminance on the basis of a potential difference between the potential of the signal line and the reference potential.

The imaging device may further include:
a constant current source that causes a constant current to flow through the signal line; and
a first switch that connects the constant current source to the signal line only in a case where the signal line is set to a reference potential.

The reset potential switch may include
a plurality of reset potential setting circuits connected in parallel between the signal line and a reference potential node, and
each of the plurality of reset potential setting circuits may include:
a voltage source having a different potential level; and
a second switch that switches whether or not to set the potential of the voltage source as the reset potential on the basis of the illuminance determined by the illuminance determination unit.

The illuminance determination unit may determine high illuminance or low illuminance, and
in a case where the illuminance determination unit determines low illuminance, the plurality of reset potential setting circuits may set, as the reset potential, the potential of the voltage source having a higher potential level than in a case where the illuminance determination unit determines high illuminance.

The reset potential switch may include
a plurality of source follower circuits, a third switch, and a current source connected in series between the signal line and a reference potential node,
each of the plurality of source follower circuits may include:
a transistor having a gate to which a potential of a different potential level is input; and
a fourth switch that switches whether or not to set the signal line to a reset potential according to the potential input to the gate of the transistor,
the third switch may be turned on when the signal line is set to a reference potential and cause a constant current to flow through the signal line using the current source, and
after the signal line is set to the reference potential, one of the plurality of fourth switches may be turned on on the basis of the illuminance determined by the illuminance determination unit and set the reset potential of the signal line.

The illuminance determination unit may determine high illuminance or low illuminance, and
in a case where the illuminance determination unit determines low illuminance, the plurality of source follower circuits may turn on the fourth switch connected to the transistor having the gate to which a higher potential than in a case where the illuminance determination unit determines high illuminance is input and set the reset potential of the signal line.

The reset potential switch may include a single voltage source connected to the signal line, and a plurality of reset potential setting circuits connected in parallel between the signal line and the voltage source,
each of the plurality of reset potential setting circuits may include a third switch that switches whether or not to select the corresponding reset potential setting circuit, and a potential setting unit connected in series with the third switch, and
the potential setting unit may include a different number of diodes connected in series or diode-connected transistors or connect the third switch to the voltage source.

The illuminance determination unit may determine high illuminance or low illuminance, and
in a case where the illuminance determination unit determines low illuminance, the plurality of reset potential setting circuits may set, as the reset potential, the potential of a larger number of diodes connected in series or diode-connected transistors than in a case where the illuminance determination unit determines high illuminance.

### BRIEF DESCRIPTION OF DRAWINGS

FIG. 1 is a block diagram illustrating a schematic configuration of an imaging device according to the present disclosure.

FIG. 2A is a schematic perspective view illustrating an example in which the imaging device according to the present disclosure has a two-layer structure.

FIG. 2B is a schematic perspective view illustrating an example in which the imaging device according to the present disclosure has a three-layer structure.

FIG. 3 is a circuit diagram illustrating main components of an imaging device according to a first embodiment.

FIG. 4 is a timing chart of the imaging device according to the first embodiment.

FIG. 5 is a circuit diagram illustrating main components of an imaging device according to a second embodiment.

FIG. 6 is a timing chart of the imaging device according to the second embodiment.

FIG. 7 is a circuit diagram illustrating main components of an imaging device according to a third embodiment.

FIG. 8 is a waveform diagram illustrating a reset potential set to a vertical signal line by a reset potential switch according to illuminance.

FIG. 9 is a circuit diagram illustrating main components of an imaging device according to a fourth embodiment.

FIG. 10 is a circuit diagram illustrating main components of an imaging device according to a fifth embodiment.

FIG. 11 is a circuit diagram illustrating main components of an imaging device according to a sixth embodiment.

FIG. 12 is a block diagram illustrating an example of a schematic configuration of a vehicle control system.

FIG. 13 is an explanatory diagram illustrating an example of installation positions of an outside-vehicle information detecting section and an imaging section.

### MODE FOR CARRYING OUT THE INVENTION

Embodiments of an imaging device will be described hereinafter with reference to the drawings. Although main components of the imaging device will be mainly described below, the imaging device can include components and functions that are not illustrated or described. The following description is not intended to exclude components and functions that are not illustrated or described.

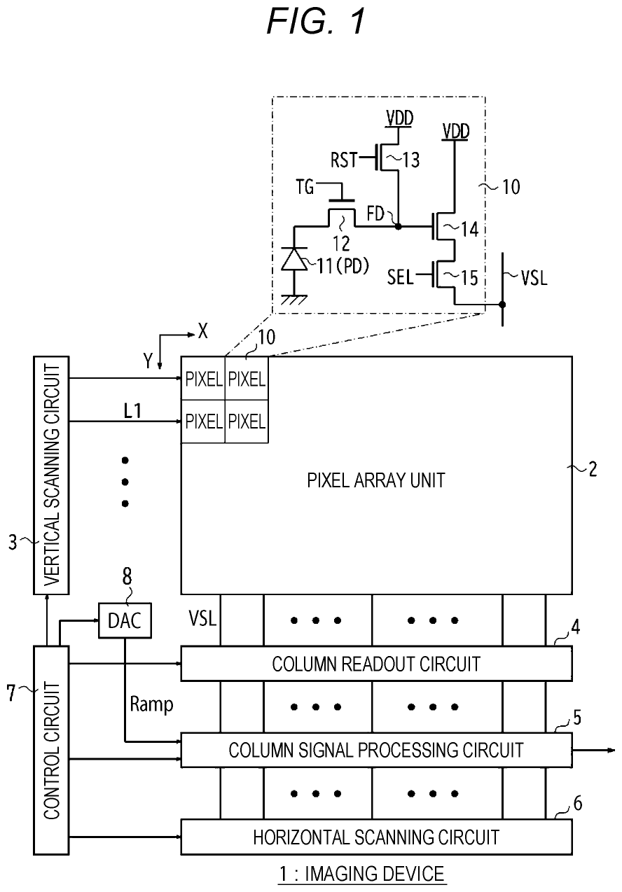

FIG. 1 is a block diagram illustrating a schematic configuration of an imaging device 1 according to the present disclosure. As illustrated in FIG. 1, the imaging device 1 according to the present disclosure includes a pixel array unit 2, a vertical scanning circuit 3, a column readout circuit 4, a column signal processing circuit 5, a horizontal scanning circuit 6, a control circuit 7, and a digital-to-analog converter (DAC hereinafter) 8.

The pixel array unit 2 includes a plurality of pixels 10. The plurality of pixels 10 is arranged in a one-dimensional or two-dimensional direction. In the present specification, a pixel array unit 2 in which a plurality of pixels 10 is arranged in each of a first direction (horizontal direction) X and a second direction (vertical direction) Y will be described. In the present specification, the plurality of pixels 10 arranged in the first direction X will be referred to as pixel rows, and the plurality of pixels 10 arranged in the second direction Y will be referred to as pixel columns. In the pixel array unit 2, a plurality of pixel rows is arranged in the second direction Y, and a plurality of pixel columns is arranged in the first direction X. In the pixel array unit 2, a vertical signal line VSL is provided for each pixel column, and a row selection line L1 is provided for each pixel row.

As described later, each pixel 10 includes a photoelectric conversion element 11, a transfer transistor 12, a reset transistor 13, an amplifier transistor 14, and a selection transistor 15. Each pixel 10 may be provided with a discharge transistor or a conversion efficiency switching transistor.

Furthermore, as described later, each pixel 10 may be provided with a plurality of photoelectric conversion elements 11 having different sensitivities.

The photoelectric conversion element 11 accumulates charge according to the amount of incident light. The photoelectric conversion element 11 is, for example, a photodiode PD. The transfer transistor 12 switches whether or not to transfer the charge accumulated in the photodiode PD to a floating diffusion FD. The reset transistor 13 switches whether or not to discharge the charge of the floating diffusion FD to a power supply voltage VDD node and set the floating diffusion FD to a reset signal level. The amplifier transistor 14 and the selection transistor 15 together constitute a source follower circuit, and generate a pixel signal according to the charge accumulated in the floating diffusion FD and output the pixel signal to the vertical signal line VSL. The selection transistor 15 outputs the pixel signal to the vertical signal line VSL when the selection signal is at a high level.

The vertical scanning circuit 3 sequentially drives a plurality of row selection lines L1. For example, the vertical scanning circuit 3 sets a row selection line L1 to be driven to a high-level potential. As a result, the selection signal of each pixel 10 included in a pixel row connected to the row selection line L1 to be driven becomes the high level, and the selection transistor 15 is turned on.

The column readout circuit 4 includes a plurality of current sources that draw currents flowing through the plurality of vertical signal lines VSL arranged in the first direction X. In addition, the column readout circuit 4 may include a plurality of capacitors that hold charge according to potentials of the plurality of vertical signal lines VSL. The column readout circuit 4 may be referred to as a load MOS circuit.

The column signal processing circuit 5 generates a digital signal on the basis of a result of comparing the potentials of the plurality of vertical signal lines VSL with a reference signal (also referred to as a ramp signal) Ramp. As described later, the column signal processing circuit 5 includes a plurality of analog-digital converters (AD converters). Each AD converter includes a comparator and a counter. The comparator compares the potential of the corresponding vertical signal line VSL with the reference signal Ramp. The reference signal Ramp is generated by the DAC 8. The counter performs a counting operation until matching between the potential of the vertical signal line VSL and the reference signal Ramp is detected by the comparator. A count value of the counter corresponds to the digital signal. The column signal processing circuit 5 can also perform correlated double sampling (CDS) processing for detecting a difference between a noise potential and a signal potential.

The horizontal scanning circuit 6 sequentially selects and outputs digital signals output from the plurality of AD converters corresponding to the plurality of vertical signal lines VSL arranged in the first direction X.

The control circuit 7 controls operation timings of the vertical scanning circuit 3, the column readout circuit 4, the column signal processing circuit 5, the horizontal scanning circuit 6, and the DAC 8.

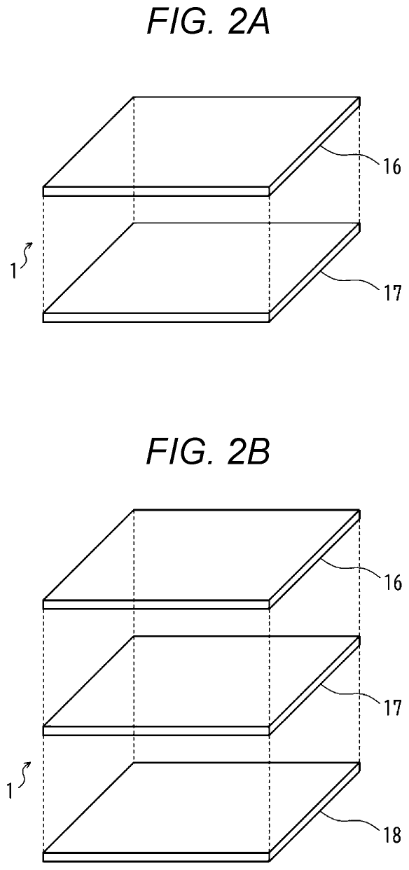

The imaging device 1 according to the present disclosure can be achieved by a chip having a multilayer structure. FIG. 2A is a schematic perspective view illustrating an example in which the imaging device 1 according to the present disclosure has a two-layer structure. The imaging device 1 in FIG. 2A includes a first substrate 16 disposed on a light incident surface side and a second substrate 17 stacked on the first substrate 16. On the first substrate 16, for example, the photodiode PD, the transfer transistor 12, the reset transistor 13, the amplifier transistor 14, and the selection transistor 15 of each pixel 10 are arranged. On the second substrate 17, for example, the vertical scanning circuit 3, the column readout circuit 4, the column signal processing circuit 5, the horizontal scanning circuit 6, and the control circuit 7 are arranged. The first substrate 16 and the second substrate 17 perform bonding and signal transmission by, for example, cupper-cupper connection (CCC). Alternatively, the first substrate 16 and the second substrate 17 may be bonded by vias or bumps instead of the CCC.

FIG. 2B is a schematic perspective view illustrating an example in which the imaging device 1 according to the present disclosure has a three-layer structure. The imaging device 1 in FIG. 2B includes a first substrate 16 disposed on the light incident surface side, a second substrate 17 stacked on the first substrate 16, and a third substrate 18 stacked on the second substrate 17. On the first substrate 16, for example, the photodiode PD and the transfer transistor 12 of each pixel 10 are arranged. On the second substrate 17, for example, pixel transistors of each pixel 10 other than the transfer transistor 12 (the reset transistor 13, the amplifier transistor 14, the selection transistor 15, and the like) are arranged. In addition, some circuits among the vertical scanning circuit 3, the column readout circuit 4, the column signal processing circuit 5, the horizontal scanning circuit 6, and the DAC 8 are arranged on the second substrate 17, and the remaining circuits are arranged on the third substrate 18. The first substrate 16 and the second substrate 17 perform bonding and signal transmission by, for example, through silicon vias (TSVs), and the second substrate 17 and the third substrate 18 perform bonding and signal transmission by, for example, CCC.

### First Embodiment

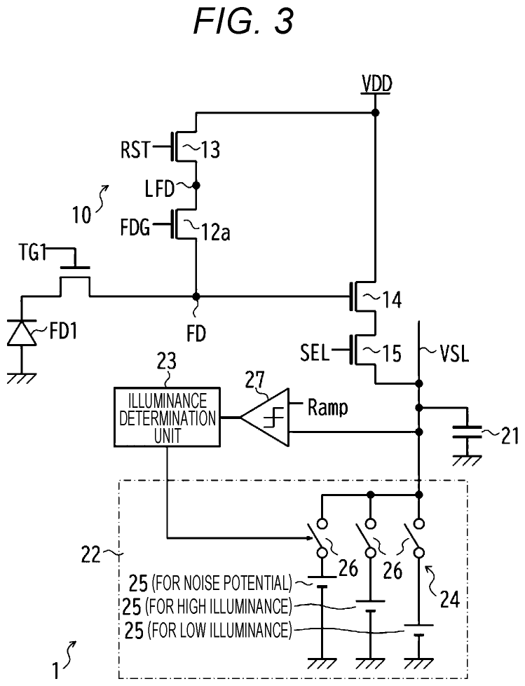

FIG. 3 is a circuit diagram illustrating main components of an imaging device 1 according to a first embodiment. More specifically, FIG. 3 illustrates a circuit configuration of a pixel 10, a column readout circuit 4, and a column signal processing circuit 5 connected to one vertical signal line VSL.

The pixel 10 according to the first embodiment includes a photodiode PD, a floating diffusion FD, a transfer transistor 12, a reset transistor 13, an amplifier transistor 14, and a selection transistor 15 as well as a conversion efficiency switching transistor 19. A charge holding unit LFD is connected to the conversion efficiency switching transistor 19 separately from the floating diffusion FD.

The pixel 10 performs photoelectric conversion with high conversion efficiency when the conversion efficiency switching transistor 19 is off, and performs photoelectric conversion with low conversion efficiency when the conversion efficiency switching transistor 19 is on. In the present specification, a mode for performing photoelectric conversion with high conversion efficiency will be referred to as high conversion gain (HCG), and a mode for performing photoelectric conversion with low conversion efficiency will be referred to as low conversion gain (LCG). The transistors provided in the pixel 10 will be collectively referred to as pixel transistors. In the present specification, an example in which the pixel transistors are NMOS transistors will be described, but the pixel transistors may be PMOS transistors.

The amplifier transistor 14 and the selection transistor 15 constitute a source follower circuit, and a source of the selection transistor 15 is connected to the vertical signal line VSL. The vertical signal line VSL is connected to a capacitor 21 that accumulates charge according to an FD potential via the source follower circuit.

Since, in the circuit of FIG. 3, the charge according to the FD potential is accumulated in the capacitor 21 connected to the vertical signal line VSL via the source follower circuit, the source follower circuit can be referred to as a dynamic source follower circuit.

When the FD potential rises, the dynamic source follower circuit can quickly accumulate, in the capacitor 21, charge according to the rise in the FD potential, but does not have a function of discharging charge from the capacitor 21 when the FD potential drops.

Therefore, the imaging device 1 according to the first embodiment includes a reset potential switch 22 that forcibly sets the vertical signal line VSL to a reset potential. The reset potential switch 22 is disposed for each vertical signal line VSL. The reset potential switch 22 is provided, for example, in the column readout circuit 4. The reset potential switch 22 can switch the reset potential according to illuminance.

The imaging device 1 according to the first embodiment includes an illuminance determination unit 23 for each vertical signal line VSL. The illuminance determination unit 23 determines illuminance of light incident on a plurality of pixels 10 connected to the corresponding vertical signal line VSL. The illuminance determination unit 23 is provided, for example, in the column signal processing circuit 5. More specifically, the illuminance determination unit 23 is connected to an output node of a comparator 27 of the column signal processing circuit 5. The illuminance determination unit 23 determines the illuminance in at least two stages. Although an example in which the illuminance determination unit 23 determines high illuminance or low illuminance will be described in the present specification, the illuminance determination unit 23 may determine illuminance in three or more stages, instead. As described above, the illuminance determination unit 23 determines the illuminance on the basis of a signal potential of a pixel signal according to the amount of light incident on the plurality of pixels. More specifically, the illuminance determination unit 23 determines the illuminance on the basis of the signal potential of the pixel signal in a state where the photoelectric conversion efficiency is maximum.

The reset potential switch 22 described above switches the reset potential for initializing the potential of the vertical signal line VSL on the basis of the illuminance determined by the illuminance determination unit 23. In a case where low illuminance is determined, the reset potential switch 22 sets the reset potential higher than that in a case where high illuminance is determined. This is because the signal potential of the pixel signal is higher in the case of low illuminance than in the case of high illuminance and, in a case where the reset potential is lowered, it is necessary to greatly change the potential of the vertical signal line VSL, which increases the time taken to settle the vertical signal line VSL.

In addition, the reset potential switch 22 sets the reset potential in a case where the vertical signal line VSL has a noise potential to be higher than the reset potential in a case where the illuminance determination unit 23 determines low illuminance. The noise potential is the potential of the vertical signal line VSL in a case where the photodiode PD does not perform photoelectric conversion, and because a signal level of the pixel signal according to the noise potential is higher than a signal level of the pixel signal at low illuminance, the reset potential for the noise potential is set high in advance.

As illustrated in FIG. 3, the reset potential switch 22 according to the first embodiment includes a plurality of reset potential setting circuits 24 connected in parallel between the corresponding vertical signal line VSL and a reference voltage node (for example, a ground node). In the example of FIG. 3, three reset potential setting circuits 24 are provided. The reset potential setting circuits 24 include voltage sources 25 having different potential levels and switches (second switches) 26 that switch whether or not to set potentials of the corresponding voltage sources 25 as the reset potential on the basis of the illuminance determined by the illuminance determination unit 23. The plurality of voltage sources 25 may be provided outside the imaging device 1. In this case, a pad for applying voltages from the plurality of voltage sources 25 provided outside is provided in the imaging device 1. As described above, the reset potential switch 22 selects one of a plurality of input potentials having different potential levels as the reset potential. The plurality of input potentials includes at least three types of input potentials for setting the noise potential, the reset potential for low illuminance, or the reset potential for high illuminance to the vertical signal line VSL.

The imaging device 1 of FIG. 3 includes a voltage source 25 that supplies a potential for the noise potential, a voltage source 25 that supplies the potential for low illuminance, a voltage source 25 that supplies the potential for high illuminance, and three switches 26 connected to the corresponding voltage sources 25. Only one of the three switches 26 is turned on, and the potential of the voltage source 25 connected to the turned on switch 26 is set as the reset potential of the vertical signal line VSL.

As illustrated in FIG. 3, the illuminance determination unit 23 is connected to the output node of the comparator 27 of the column signal processing circuit 5. As described later, the illuminance determination unit 23 determines the illuminance on the basis of, for example, the amount of light incident on the pixel 10. The pixel 10 outputs a pixel signal having a signal potential according to the amount of incident light to the vertical signal line VSL. The comparator 27 outputs a result of comparison between the potential of the vertical signal line VSL and the reference signal Ramp. The illuminance determination unit 23 determines the illuminance on the basis of an output signal of the comparator 27. The reference signal Ramp is a ramp signal whose potential changes with time. In a case where the reference signal Ramp is a ramp signal whose potential decreases as time elapses, the lower the potential of the vertical signal line VSL, the slower the comparator 27 detects coincidence. When detecting the coincidence, the comparator 27 changes logic of the output signal. For example, illuminance determination unit 23 can determine high illuminance or low illuminance on the basis of the length of time until the logic of the output signal of comparator 27 changes.

The three switches 26 of the reset potential setting circuit 24 are switched on or off on the basis of a result of the determination by the illuminance determination unit 23. Specifically, if the illuminance determination unit 23 determines high illuminance, the switch 26 connected to the voltage source 25 that supplies the potential for high illuminance is turned on. Specifically, if the illuminance determination unit 23 determines low illuminance, the switch 26 connected to the voltage source 25 that supplies the potential for low illuminance is turned on. In addition, in a case where the noise potential is read, the switch 26 connected to the voltage source 25 that supplies the potential for the noise potential is turned on.

FIG. 3 illustrates the circuit configuration of the column readout circuit 4 and the column signal processing circuit 5 connected to one vertical signal line VSL, but a circuit similar to that in FIG. 3 is connected to each of the plurality of vertical signal lines VSL arranged in the first direction X.

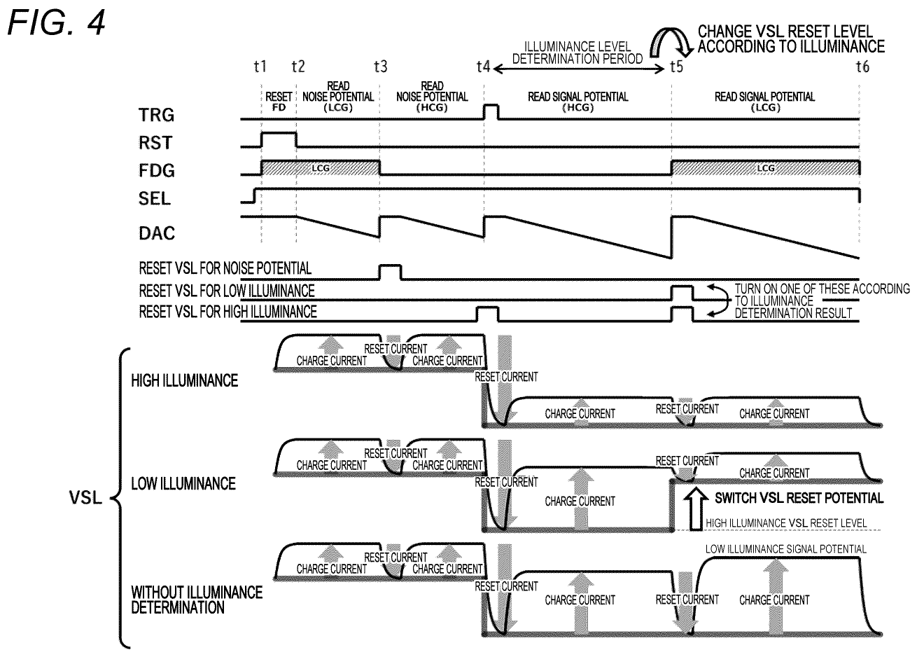

FIG. 4 is a timing chart of the imaging device 1 according to the first embodiment. FIG. 4 illustrates waveforms of a gate voltage TRG of the transfer transistor 12, a gate voltage RST of the reset transistor 13, a gate voltage FDG of the conversion efficiency switching transistor 19, a gate voltage SEL of the selection transistor 15, the reference signal Ramp output from the DAC 8, on/off timings of the three switches 26 of the reset potential setting circuit 24, the potential of the vertical signal line VSL at the high illuminance, the potential of the vertical signal line VSL at the low illuminance, and the potential of the vertical signal line VSL in a case where the illuminance determination is not performed. Operation of the light-emitting device according to the first embodiment will be described hereinafter with reference to FIG. 4.

Although the imaging device 1 according to the first embodiment includes the illuminance determination unit 23, it is also possible to select a mode in which the illuminance determination by the illuminance determination unit 23 is not performed. In this case, the potential of the vertical signal line VSL has a waveform in a case where the illuminance determination is not performed, which is illustrated in a lowermost part of FIG. 4.

FIG. 4 illustrates an example of driving the row selection line L1 of a certain pixel row, and the selection transistor 15 of every pixel 10 included in this pixel row is turned on. From a time t1 to a time t2, the reset transistor 13 is turned on to extract charge (electrons) of the floating diffusion FD to the power supply voltage VDD node, thereby resetting the FD potential. During a period from the time t1 to a time t3, the conversion efficiency switching transistor 19 is turned on, and charge (electrons) held in the charge holding unit LFD connected to the conversion efficiency switching transistor 19 is also extracted to the power supply voltage VDD node. Between times t1 and t2, the signal level of the reference signal Ramp output from the DAC 8 is constant (high-level potential).

During a period from the time t2 to the time t3, the signal level of the reference signal Ramp output from the DAC 8 gradually decreases. The period from time t2 to time t3 is a noise potential readout period with low conversion efficiency. At the time t3, the switch 26 connected to the voltage source 25 for the noise potential in the reset potential switch 22 is temporarily turned on. As a result, the vertical signal line VSL is set to the reset potential for the noise potential. Furthermore, at the time t3, the reference signal Ramp output from the DAC 8 returns to the original high-level potential, and then the signal level of the reference signal Ramp gradually decreases until a time t4. Furthermore, at the time t3, the conversion efficiency switching transistor 19 is turned off.

A period from the time t3 to a time t4 is a noise potential readout period with high conversion efficiency. At the time t4, the switch 26 connected to the voltage source 25 for high illuminance in the reset potential switch 22 is temporarily turned on. As a result, the vertical signal line VSL is set to the reset potential for high illuminance. As described above, at time t4 when the reading of the noise potential is finished, the vertical signal line VSL is lowered to the reset potential for high illuminance regardless of the illuminance. Furthermore, at the time t4, the reference signal Ramp output from the DAC 8 returns to the original high-level potential, and then the signal level of the reference signal Ramp gradually decreases until a time t5.

During a period from the time t1 to the time t4, the noise potential is read in a state where the reset potential for the noise potential is set in the vertical signal line VSL, regardless of the illuminance of the light incident on the pixel 10.

A period from the time t4 to a time t5 is a signal potential readout period with high conversion efficiency. In addition, the illuminance determination unit 23 determines the illuminance between the times t4 and t5. Since the vertical signal line VSL is set to the reset potential for high illuminance at the time t4, the potential of the vertical signal line VSL does not rise so much in the case of high illuminance, but the potential of the vertical signal line VSL greatly rises in the case of low illuminance between the times t4 and t5.

At the time t5, the conversion efficiency switching transistor 19 is turned on, and the signal potential is read with low conversion efficiency during a period from time t5 to time t6. At the time t5, the switch 26 connected to the voltage source 25 for high illuminance or the switch 26 connected to the voltage source 25 for low illuminance in the reset potential switch 22 is turned on according to the illuminance determined by the illuminance determination unit 23. If the illuminance determination unit 23 determines high illuminance, the switch 26 connected to the voltage source 25 for high illuminance is turned on, and the vertical signal line VSL is set to the reset potential for high illuminance. If the illuminance determination unit 23 determines low illuminance, the switch 26 connected to the voltage source 25 for low illuminance is turned on, and the vertical signal line VSL is set to the reset potential for low illuminance. In this case, the potential of the vertical signal line VSL is increased higher than at the time t4. In addition, in a case where the illuminance determination unit 23 does not perform the illuminance determination, a reset potential similar to that in a case where high illuminance is determined is set to the vertical signal line VSL at the time t5.

As described above, in the first embodiment, since the signal potential of the pixel signal is read after the reset potential of the potential level according to the illuminance determined by the illuminance determination unit 23 is set to the vertical signal line VSL (time t5), the amount of variation in the potential of the vertical signal line VSL can be reduced, the settling time of the vertical signal line VSL can be shortened, and a current flowing through the vertical signal line VSL can be reduced to achieve power saving.

### Second Embodiment

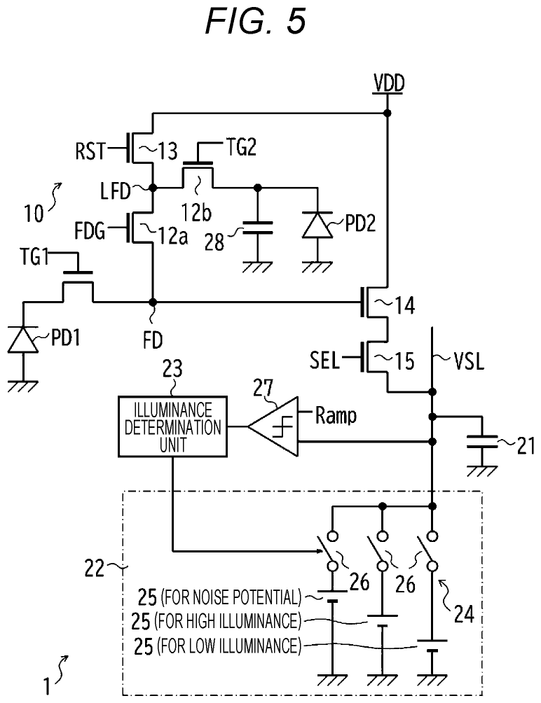

FIG. 5 is a circuit diagram illustrating main components of an imaging device 1 according to a second embodiment. The imaging device 1 according to the second embodiment includes pixels 10 having a configuration different from that in the imaging device 1 according to the first embodiment. The pixels 10 according to the second embodiment each include a plurality of photoelectric conversion elements 11 (for example, photodiodes PD) having different light receiving areas. In the example of FIG. 5, two photodiodes PD having different light receiving areas are provided, but three or more photodiodes PD may be provided. The two photodiodes PD provided in the pixel 10 in FIG. 5 will be referred to as a first photodiode PD1 and a second photodiode PD2. For example, the first photodiode PD1 has a larger light receiving area than the second photodiode PD2. As the light receiving area becomes larger, weaker light can be detected, but saturation more easily occurs. A dynamic range can be expanded by providing a plurality of photodiodes PD having different light receiving areas in the pixel 10.

Furthermore, the pixel 10 in FIG. 5 includes a charge holding unit 28 that holds charge accumulated in the second photodiode PD2 and a second transfer transistor 12b that switches whether or not to connect a source of the reset transistor 13 and a cathode of the second photodiode PD2. A transistor that transfers the charge accumulated in the first photodiode PD1 to the floating diffusion FD will be referred to as a first transfer transistor 12a.

The imaging device 1 according to the second embodiment is configured similarly to the imaging device 1 according to the first embodiment except that the configuration of the pixel 10 is different from that in the first embodiment.

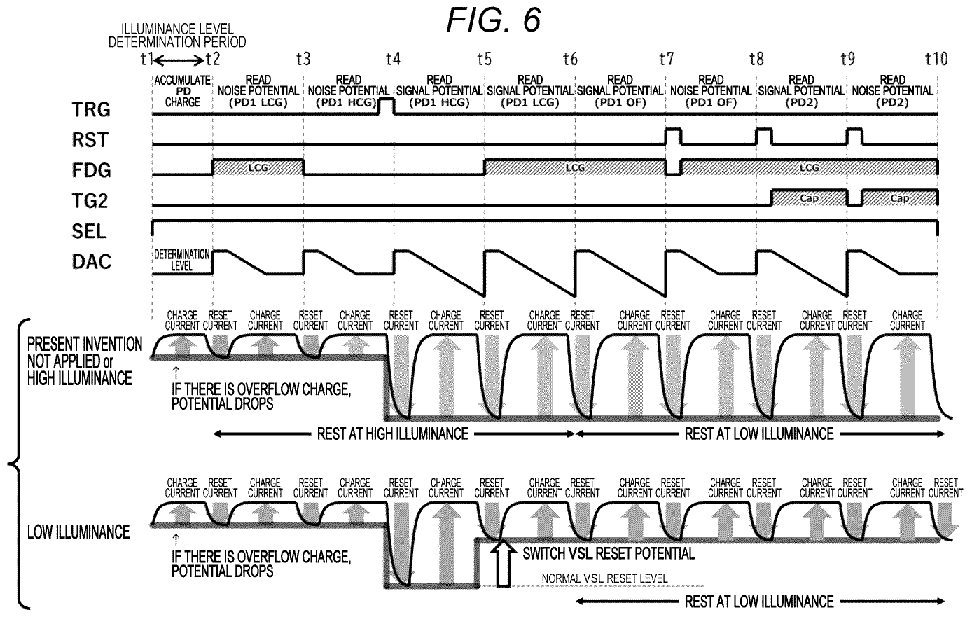

FIG. 6 is a timing chart of the imaging device 1 according to the second embodiment. FIG. 6 illustrates gate potential waveforms of the first transfer transistor 12a, the reset transistor 13, the conversion efficiency switching transistor 19, the second transfer transistor 12b, and the selection transistor 15, a potential waveform of the reference signal Ramp output from the DAC 8, and a potential waveform of the vertical signal line VSL. The potential waveform of the vertical signal line VSL includes a potential waveform in a case where the illuminance determination is not performed or in a case of high illuminance and a potential waveform in a case of low illuminance.

In the first embodiment, the illuminance determination unit 23 determines the illuminance after reading the noise potential, but in the second embodiment, the illuminance determination unit 23 determines the illuminance before reading the noise potential. More specifically, in the first embodiment, the illuminance is determined on the basis of the charge generated by the photoelectric conversion of the photodiode PD, but in the second embodiment, the illuminance is determined on the basis of the charge overflowing from the photodiode PD to the floating diffusion FD in a state where the first transfer transistor 12a is turned off.

At a time t1 in FIG. 6, the vertical signal line VSL is set to the reset potential of the noise potential regardless of the illuminance. During a period from the time t1 to a time t2, the first photodiode PD1 performs exposure. Charge that cannot be accumulated in the first photodiode PD1 and that has overflown is transferred to the floating diffusion FD. The FD potential becomes a potential according to the charge accumulated in the floating diffusion FD. The FD potential decreases as the charge overflowing from the first photodiode PD1 increases. The vertical signal line VSL has a potential according to the FD potential.

The illuminance determination unit 23 determines illuminance on the basis of the potential of the vertical signal line VSL between the times t1 and t2. That is, the illuminance determination unit 23 determines the illuminance on the basis of the charge overflowing from the first photodiode PD1. The higher the illuminance, the more the charge overflows from the first photodiode PD1, and the FD potential and the potential of the vertical signal line VSL further decrease. The illuminance determination unit 23 determines, for example, high illuminance or low illuminance on the basis of the potential of the vertical signal line VSL. As described above, before the transfer of charge by photoelectric conversion from the photoelectric conversion element 11 to the floating diffusion FD via the transfer transistor 12 is started, the illuminance determination unit 23 determines the illuminance on the basis of the charge leaking from the photoelectric conversion element 11 to the floating diffusion FD.

The DAC 8 sets the signal level of the reference signal Ramp to the low level between the times t1 and t2, increases the signal level to the high-level potential at the time t2, and then gradually decreases the signal level of the reference signal Ramp. Since the conversion efficiency switching transistor 19 is turned on between the times t2 and t3, the noise potential is read with low conversion efficiency.

At the time t3, the conversion efficiency switching transistor 19 is turned off. The DAC 8 increases the signal level of the reference signal Ramp to the high level at the time t3, and then gradually decreases the signal level of the reference signal Ramp. In a period from the time t3 to a time t4, the noise potential is read with high conversion efficiency.

Immediately before the time t4, the first transfer transistor 12a is turned on. At the time t4, the reset potential switch 22 sets the vertical signal line VSL to the reset potential for high illuminance regardless of the illuminance. In a period from the time t4 to a time t5, the signal potential is read with high conversion efficiency.

At the time t5, the reset potential switch 22 sets the reset potential of the vertical signal line VSL on the basis of a result of the determination of the illuminance by the illuminance determination unit 23 performed between the times t1 and t2. For example, the reset potential switch 22 sets the reset potential for high illuminance to the vertical signal line VSL if the illuminance determination unit 23 determines high illuminance, and sets the reset potential for low illuminance to the vertical signal line VSL if the illuminance determination unit 23 determines low illuminance. As illustrated in FIG. 6, if the illuminance determination unit 23 determines low illuminance, the reset potential switch 22 sets the potential level of the reset potential higher than that in a case where the illuminance determination unit 23 determines high illuminance.

Furthermore, after the time t5, the conversion efficiency switching transistor 19 is turned on. Between times t5 to t6 and times t6 to t7, the signal potential is read with low conversion efficiency. The DAC 8 increases the reference signal Ramp to the high-level potential at the time t5, and then gradually decreases the reference signal Ramp until the time t6. Similarly, the DAC 8 increases the reference signal Ramp to the high-level potential at the time t6, and then gradually decreases the reference signal Ramp until the time t7.

At the time t7, the reset transistor 13 is temporarily turned on. As a result, the charge accumulated in the floating diffusion FD is discharged to the power supply voltage VDD node via the reset transistor 13. In a period from the time t7 to a time t8, the noise potential is read.

At the time t8, the reset transistor 13 is temporarily turned on. In addition, the second transfer transistor 12b is turned on slightly after the time t8. As a result, charge according to the amount of photoelectric conversion by the second photodiode PD2 is accumulated in the floating diffusion FD. From the time t8 to a time t9, a signal potential obtained as a result of the photoelectric conversion by the second photodiode PD2 is read.

At the time t9, the reset transistor 13 is temporarily turned on. As a result, the charge accumulated in the floating diffusion FD is discharged to the power supply voltage VDD node via the reset transistor 13. During a period from the time t9 to a time t10, the noise potential of the second photodiode PD2 is read.

At a time of high illuminance, the counting operation of the counter provided at a subsequent stage of the comparator 27 of the column signal processing circuit 5 is stopped between the times t2 and t6. At the time of high illuminance, digital signals of the noise potential and the signal potential are generated by performing the counting operation of the counter after the time t6. In addition, at the time of low illuminance, the counting operation of the counter of the column signal processing circuit 5 is stopped between the times t6 and t10. At a time of low illuminance, digital signals of the noise potential and the signal potential are generated by performing the counting operation of the counter between the times t2 and t6. As illustrated in the timing chart of FIG. 6, after the illuminance determination unit 23 determines the illuminance, the reset potential switch 22 according to the second embodiment sets the reset potential according to the noise potential to the vertical signal line VSL and reads the noise potential, and then, for each of the plurality of photoelectric conversion elements 11, the reset potential according to the illuminance determined by the illuminance determination unit 23 is sequentially set to the vertical signal line VSL and the signal potential is read.

As described above, in the second embodiment, if the illuminance determination unit 23 determines high illuminance between the times t1 and t2 in FIG. 6, or in a case where the illuminance determination unit 23 does not perform the illuminance determination, the reset potential switch 22 turns on the switch 26 connected to the voltage source 25 for high illuminance at the times t4 and t5, and sets the reset potential for high illuminance to the vertical signal line VSL. If the illuminance determination unit 23 determines low illuminance between the times t1 and t2, on the other hand, the reset potential switch 22 sets the reset potential for high illuminance to the vertical signal line VSL at the time t4 and sets the reset potential for low illuminance to the vertical signal line VSL at the time t5. Therefore, after the time t5, the amount of variation in the potential of the vertical signal line VSL is suppressed, the settling time of the vertical signal line VSL can be shortened, and the current flowing through the vertical signal line VSL can be reduced to achieve power saving.

### Third Embodiment

In a third embodiment, a reference potential of the vertical signal line VSL for performing the illuminance determination is generated by a reference signal generation circuit.

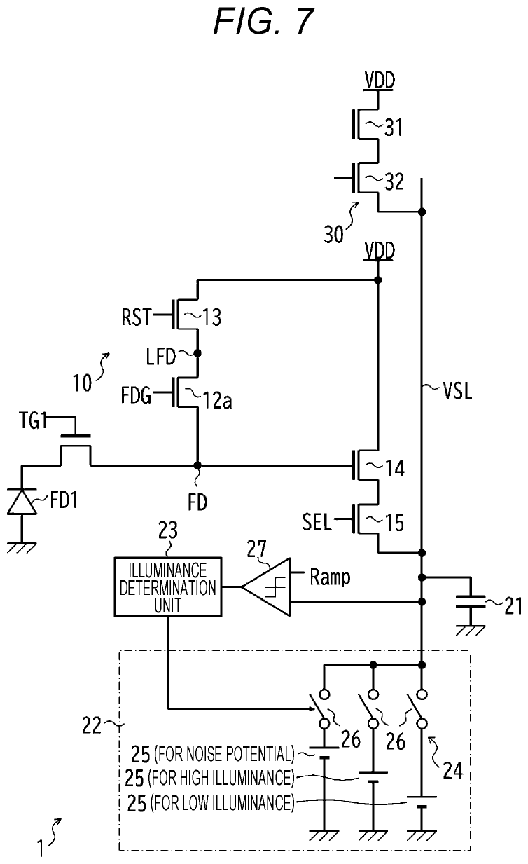

FIG. 7 is a circuit diagram illustrating main components of an imaging device 1 according to the third embodiment. The imaging device 1 according to the third embodiment is obtained by adding a reference signal generation circuit 30 to the circuit configuration of FIG. 3. The reference signal generation circuit 30 generates a reference signal for setting the vertical signal line VSL to the reference potential. The reference signal generation circuit 30 includes two transistors 31 and 32 cascode-connected between the power supply voltage VDD node and the vertical signal line VSL. The transistors 31 and 32 are, for example, NMOS transistors. These transistors 31 and 32 output, for example, a pixel signal according to a potential of a floating diffusion FD of a dummy pixel (not illustrated) to the vertical signal line VSL. The dummy pixel is a pixel that blocks light, and can output a pixel signal having a stable signal level. Alternatively, gate voltages of the two transistors 31 and 32 may be controlled from the outside.

The reference signal generation circuit 30 is a source follower circuit. A current flowing through the two transistors 31 and 32 in the reference signal generation circuit 30 flows to the capacitor 21 via the vertical signal line VSL. As a result, the vertical signal line VSL becomes a potential according to the charge held in the capacitor 21. The reference signal generation circuit 30 thus constitutes a dynamic source follower circuit in order to cause the capacitor 21 connected to the vertical signal line VSL to hold charge according to the current flowing through the two transistors 31 and 32.

The charge according to the reference signal generated by the reference signal generation circuit 30 is held in the capacitor 21, and the vertical signal line VSL is set to the reference potential. After the reference signal generation circuit 30 sets the vertical signal line VSL to the reference potential, the illuminance determination unit 23 determines the illuminance on the basis of the amount of variation in potential from the reference potential. Thereafter, the reset potential switch 22 sets the reset potential for high illuminance or low illuminance to the vertical signal line VSL on the basis of the illuminance determined by the illuminance determination unit 23.

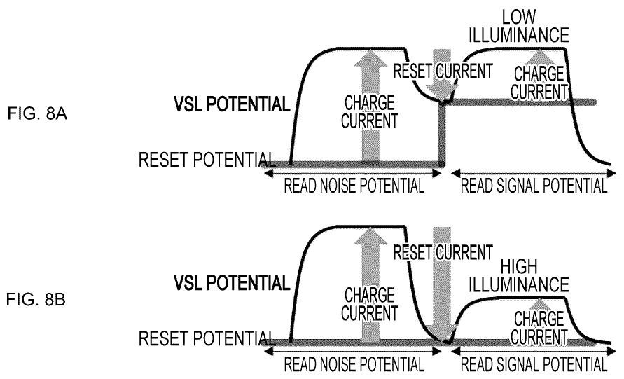

FIG. 8 shows waveform diagrams illustrating reset potentials set to the vertical signal line VSL by the reset potential switch 22 according to the illuminance determined by the illuminance determination unit 23: FIG. 8A is a waveform diagram illustrating a reset potential in the case of low illuminance, and FIG. 8B is a waveform diagram illustrating a reset potential in the case of high illuminance. For example, the illuminance determination unit 23 determines the illuminance at a timing when the reading of the noise potential is finished, and the reset potential switch 22 switches the reset potential of the vertical signal line VSL on the basis of a result of the determination. Note that, as described in the first embodiment, the illuminance may be determined before the noise potential is read.

As described above, in the third embodiment, since the illuminance determination unit 23 determines the illuminance after the reference signal generation circuit 30 sets the vertical signal line VSL to the reference potential, variations in the result of the determination of the illuminance are less likely to occur for each vertical signal line VSL.

### Fourth Embodiment

A fourth embodiment is different from the third embodiment in the circuit configuration of the reference signal generation circuit 30.

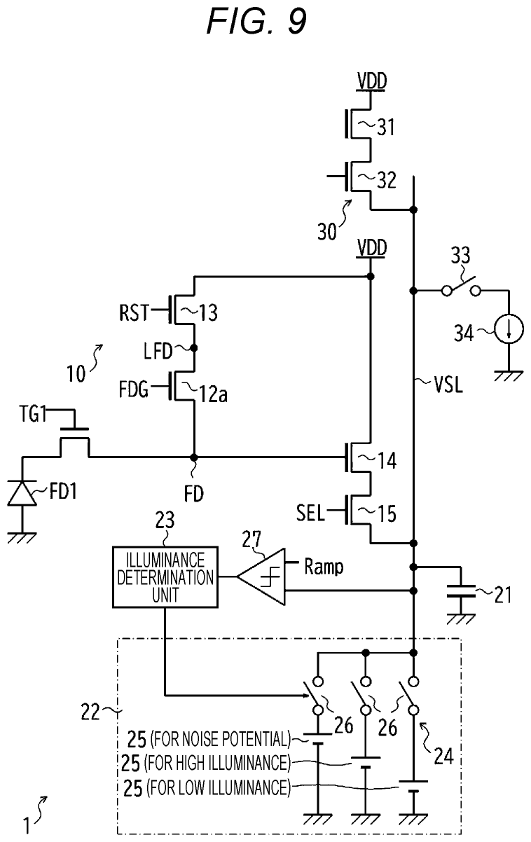

FIG. 9 is a circuit diagram illustrating main components of an imaging device 1 according to the fourth embodiment. The imaging device 1 according to the fourth embodiment includes a reference signal generation circuit 30 having a configuration different from that in the third embodiment. As illustrated in FIG. 9, the reference signal generation circuit 30 according to the fourth embodiment includes a switch 33 and a current source 34 connected in series between the vertical signal line VSL and a reference voltage (for example, ground) node in addition to the two transistors 31 and 32 cascode-connected between the power supply voltage VDD node and the vertical signal line VSL.

The switch 33 is turned on in a case where the vertical signal line VSL is set to the reference potential. When the switch 33 is turned on, the current flowing through the two transistors 31 and 32 in the reference signal generation circuit 30 flows to the current source 34 via the switch 33. Since the current source 34 is a constant current source that causes a constant current to flow, the vertical signal line VSL can be set to a constant reference potential.

In the fourth embodiment, after the switch 33 is turned on and the vertical signal line VSL is set to the reference potential with a constant current load, the illuminance determination unit 23 determines the illuminance, sets the reset potential of the vertical signal line VSL on the basis of a result of the determination, and reads the signal potential.

In the fourth embodiment, similarly to the third embodiment, since the illuminance determination unit 23 determines the illuminance after the reference signal generation circuit 30 sets the vertical signal line VSL to the reference potential, variations in the result of the determination of the illuminance are less likely to occur for each vertical signal line VSL.

### Fifth Embodiment

A fifth embodiment is different from the first to fourth embodiments in the configuration of the reset potential switch 22.

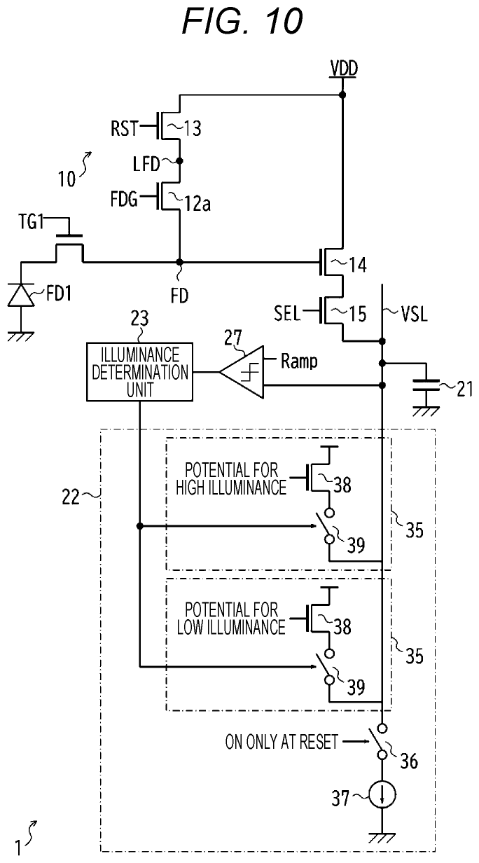

FIG. 10 is a circuit diagram illustrating main components of an imaging device 1 according to the fifth embodiment. The fifth embodiment includes a reset potential switch 22 whose configuration is different from that in the first to fourth embodiments. The reset potential switch 22 according to the fifth embodiment includes a plurality of source follower circuits 35, a switch (fourth switch) 36, and a current source 37 connected in series between the vertical signal line VSL and the reference potential (for example, ground) node.

Each of the plurality of source follower circuits 35 includes a transistor 38 and a switch (fifth switch) 39 connected in series between the power supply voltage VDD node and the vertical signal line VSL. The transistors 38 are, for example, NMOS transistors. Drains of the transistors 38 are connected to the power supply voltage VDD node, and sources are connected to ends of the switches 39. Another end of the switch 39 is connected to the vertical signal line VSL. Potentials at different potential levels are input to gates of the transistors 38.

Although FIG. 10 illustrates an example in which the two source follower circuits 35 are connected in series, three or more source follower circuits 35 may be connected in series, and potentials at different potential levels may be input to the gates of the transistors 38 in the source follower circuits 35. The two source follower circuits 35 illustrated in FIG. 10 will be referred to as a first source follower circuit 35 and a second source follower circuit 35. The reset potential for low illuminance is input to the gate of the transistor 38 in the first source follower circuit 35. The reset potential for high illuminance is input to the gate of the transistor 38 in the second source follower circuit 35.

The switch 36 is turned on when the vertical signal line VSL is set to the reference potential. When the switch 36 is turned on, a constant current flows from the vertical signal line VSL to the current source 37 via the switch 36.

After the vertical signal line VSL is set to the reference potential, the illuminance determination unit 23 determines the illuminance. Thereafter, the reset potential switch 22 turns on one of the switches 39 on the basis of the illuminance determined by the illuminance determination unit 23, and sets the vertical signal line VSL to the reset potential according to the illuminance.

In the fifth embodiment, even if the potential of a connection node of the current source 37 that discharges the reset current varies due to the illuminance of the plurality of pixels 10 to be simultaneously read, the reset potential of the vertical signal line VSL is set by the source follower circuit 35, and the reset potential is not affected by the potential variation of the connection node of the current source 37. Therefore, countermeasures against streaking can be taken.

### Sixth Embodiment

In a sixth embodiment, a single voltage source is provided in the reset potential switch 22.

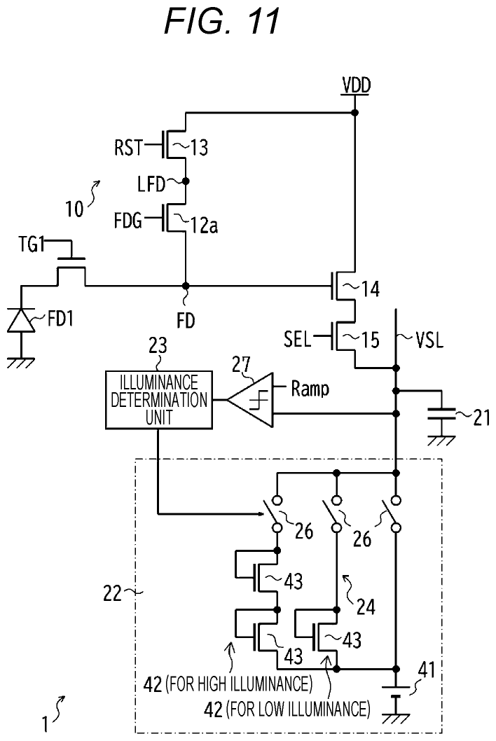

FIG. 11 is a circuit diagram illustrating main components of an imaging device 1 according to the sixth embodiment. The sixth embodiment is different from the first to fifth embodiments in the configuration of the reset potential switch 22. The reset potential switch 22 according to the sixth embodiment includes a single voltage source 41 and a plurality of reset potential setting circuits 24 connected in parallel between the vertical signal line VSL and the voltage source 25.

Each of the plurality of reset potential setting circuits 24 includes a switch 26 and a potential setting unit 42. The switches 26 switch whether or not to select the corresponding reset potential setting circuits 24. The potential setting units 42 have different numbers of diodes connected in series or diode-connected transistors 43, or connect the corresponding switches 26 to the voltage source 41.

The diodes or diode-connected transistors 43 each have a predetermined forward voltage (for example, about 0.6 V) between an anode and a cathode or between a drain and a source. Therefore, by adjusting the number of diodes or diode-connected transistors 43 connected in series, they can be used as the voltage source 41 in FIG. 3.

In the example of FIG. 10, the reset potential for the noise potential is generated by connecting two of the diode-connected transistors 43 in series. In addition, the reset potential for low illuminance is generated by using one of the diode-connected transistors 43. Moreover, the reset potential for high illuminance is generated by not connecting the diode-connected transistors 43 to the switch 26. The number of diode-connected transistors 43 connected in series is arbitrary.

According to the sixth embodiment, since a plurality of reset potentials can be generated by the single voltage source 41, the number of pads for applying a voltage from the voltage source 41 provided outside and the number of wires connected to the pads can be reduced.

### Example of Application to Mobile Body

The technology according to the present disclosure (present technology) can be applied to various products. For example, the technology according to the present disclosure may be implemented as a device to be mounted on a mobile object of any kind, such as an automobile, an electric automobile, a hybrid electric automobile, a motorcycle, a bicycle, a personal mobility, an airplane, a drone, a ship, or a robot.

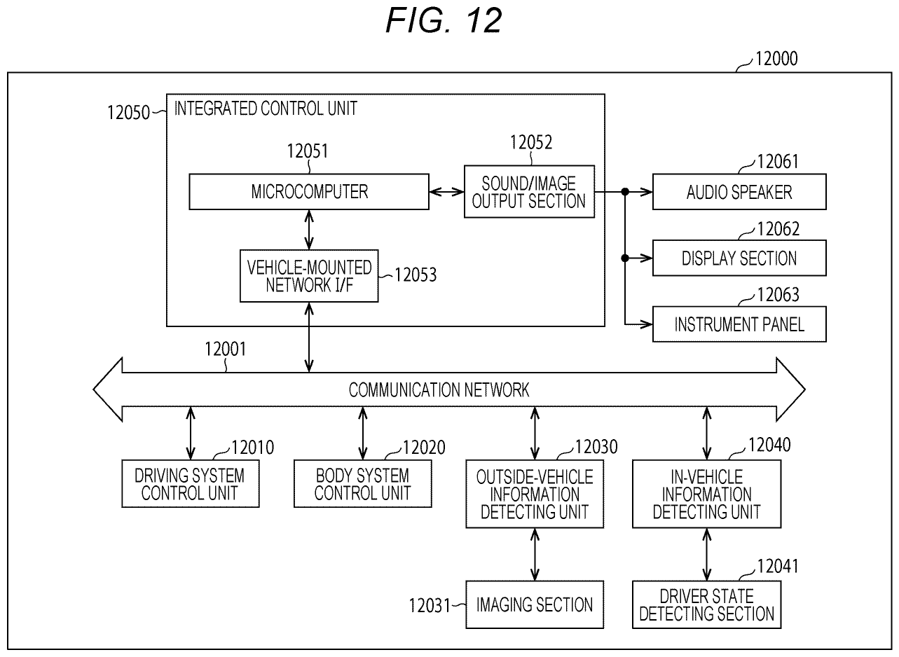

FIG. 12 is a block diagram illustrating a schematic configuration example of a vehicle control system as an example of a mobile body control system to which the technology according to the present disclosure can be applied.

The vehicle control system 12000 includes a plurality of electronic control units connected to each other via a communication network 12001. In the example illustrated in FIG. 12, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12030 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 12, as the output device, an audio speaker 12061, a display section 12062, and an instrument panel 12063 are illustrated. The display section 12062 may, for example, include at least one of an on-board display and a head-up display.

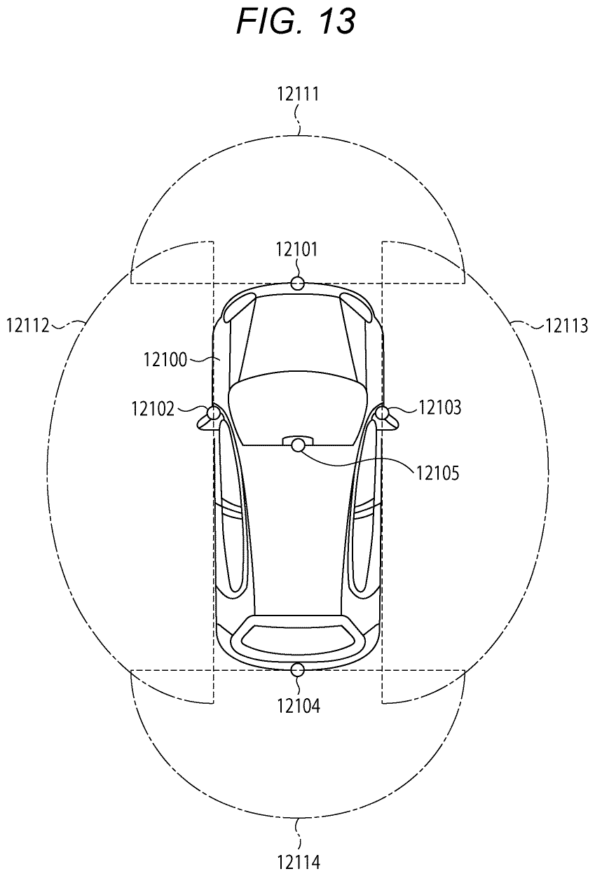

FIG. 13 is a diagram illustrating an example of installation positions of the imaging section 12031.

In FIG. 13, imaging sections 12101, 12102, 12103, 12104, and 12105 are included as the imaging section 12031.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 13 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described above. The technology according to the present disclosure can be applied to the imaging section 12031 and the like), for example, among the configurations described above. Specifically, the imaging device 1 according to each embodiment can be applied to the imaging section 12031. By applying the technology according to the present disclosure to the imaging section 12031, a more easily viewable captured image can be obtained, by which fatigue of the driver can be reduced.

Note that the present technology may have the following configurations.

(1) An imaging device including:
a plurality of pixels arranged in one direction and each including a photoelectric conversion element;
a signal line that transmits a plurality of pixel signals obtained as a result of photoelectric conversion in the plurality of pixels;
an illuminance determination unit that determines illuminance of light incident on the plurality of pixels; and
a reset potential switch that switches a reset potential for initializing a potential of the signal line on a basis of the illuminance determined by the illuminance determination unit.

(2) The imaging device according to (1), in which
the illuminance determination unit determines the illuminance in at least two stages.

(3) The imaging device according to (1) or (2), in which
the illuminance determination unit determines high illuminance or low illuminance, and
the reset potential switch sets the reset potential higher in a case where low illuminance is determined than in a case where high illuminance is determined.

(4) The imaging device according to (3), in which
the reset potential switch sets the reset potential in a case where the signal line has a noise potential to be higher than the reset potential in a case where the illuminance determination unit determines low illuminance.

(5) The imaging device according to any one of (1) to (4), further including:
a pixel array unit including the plurality of pixels arranged in a first direction and a second direction; and
a plurality of the signal lines, each of which extends in the second direction, is arranged in the first direction, and transmits two or more pixel signals obtained as a result of photoelectric conversion by two or more of the pixels arranged in the second direction, in which
the illuminance determination unit and the reset potential switch are provided for each of the plurality of signal lines.

(6) The imaging device according to any one of (1) to (5), in which
the reset potential switch selects, as the reset potential, one of a plurality of input potentials having different potential levels.

(7) The imaging device according to (6), in which
the plurality of input potentials includes at least three types of input potentials for setting a noise potential, a reset potential for low illuminance, or a reset potential for high illuminance to the signal line.

(8) The imaging device according to any one of (1) to (7), in which
each of the plurality of pixels includes a transfer transistor and a floating diffusion, and
before transfer of charge by photoelectric conversion from the photoelectric conversion element to the floating diffusion via the transfer transistor is started, the illuminance determination unit determines the illuminance on a basis of a charge leaking from the photoelectric conversion element to the floating diffusion.

(9) The imaging device according to any one of (1) to (7), in which
the illuminance determination unit determines the illuminance on a basis of signal potentials of the pixel signals according to an amount of light incident on the plurality of pixels.

(10) The imaging device according to (9), in which
the plurality of pixels is capable of switching photoelectric conversion efficiency in at least two stages, and
the illuminance determination unit determines the illuminance on a basis of the signal potentials of the pixel signals in a state where the photoelectric conversion efficiency is maximum.

(11) The imaging device according to any one of (1) to (10), further including:
a signal processing unit that performs signal processing including generation of a digital signal according to the potential of the signal line on a basis of a result of comparison between the potential of the signal line and a reference signal, in which
in a case where the signal line has a noise potential, the reset potential switch sets the reset potential according to the noise potential to the signal line, and then sets the reset potential according to the illuminance determined by the illuminance determination unit to the signal line.

(12) The imaging device according to any one of (1) to (10), in which
each of the plurality of pixels includes a plurality of the photoelectric conversion elements having different sensitivities, and
the reset potential switch sets the reset potential according to a noise potential to the signal line and reads the noise potential after the illuminance determination unit determines the illuminance, and then sequentially sets the reset potential according to the illuminance determined by the illuminance determination unit to the signal line and reads signal potentials for each of the plurality of photoelectric conversion elements.

(13) The imaging device according to any one of (1) to (12), further including:
a reference signal generation circuit that generates a reference signal for setting the signal line to a reference potential, in which
the illuminance determination unit determines the illuminance on a basis of a potential difference between the potential of the signal line and the reference potential.

(14) The imaging device according to any one of (1) to (12), further including:
a constant current source that causes a constant current to flow through the signal line; and
a first switch that connects the constant current source to the signal line only in a case where the signal line is set to a reference potential.

(15) The imaging device according to any one of (1) to (14), in which
the reset potential switch includes a plurality of reset potential setting circuits connected in parallel between the signal line and a reference potential node, and
each of the plurality of reset potential setting circuits includes:
a voltage source having a different potential level; and
a second switch that switches whether or not to set the potential of the voltage source as the reset potential on a basis of the illuminance determined by the illuminance determination unit.

(16) The imaging device according to (15), in which
the illuminance determination unit determines high illuminance or low illuminance, and
in a case where the illuminance determination unit determines low illuminance, the plurality of reset potential setting circuits sets, as the reset potential, the potential of the voltage source having a higher potential level than in a case where the illuminance determination unit determines high illuminance.

(17) The imaging device according to any one of (1) to (14), in which
the reset potential switch includes a plurality of source follower circuits, a third switch, and a current source connected in series between the signal line and a reference potential node,
each of the plurality of source follower circuits includes:
a transistor having a gate to which a potential of a different potential level is input; and
a fourth switch that switches whether or not to set the signal line to a reset potential according to the potential input to the gate of the transistor,
the third switch is turned on when the signal line is set to a reference potential and causes a constant current to flow through the signal line using the current source, and
after the signal line is set to the reference potential, one of the plurality of fourth switches is turned on on a basis of the illuminance determined by the illuminance determination unit and sets the reset potential of the signal line.

(18) The imaging device according to (17), in which
the illuminance determination unit determines high illuminance or low illuminance, and
in a case where the illuminance determination unit determines low illuminance, the plurality of source follower circuits turns on the fourth switch connected to the transistor having the gate to which a higher potential than in a case where the illuminance determination unit determines high illuminance is input and sets the reset potential of the signal line.

(19) The imaging device according to any one of (1) to (14), in which
the reset potential switch includes a single voltage source connected to the signal line, and a plurality of reset potential setting circuits connected in parallel between the signal line and the voltage source,
each of the plurality of reset potential setting circuits includes a third switch that switches whether or not to select the corresponding reset potential setting circuit, and a potential setting unit connected in series with the third switch, and
the potential setting unit includes a different number of diodes connected in series or diode-connected transistors or connects the third switch to the voltage source.

(20) The imaging device according to (19), in which
the illuminance determination unit determines high illuminance or low illuminance, and
in a case where the illuminance determination unit determines low illuminance, the plurality of reset potential setting circuits sets, as the reset potential, the potential of a larger number of diodes connected in series or diode-connected transistors than in a case where the illuminance determination unit determines high illuminance.

Aspects of the present disclosure are not limited to the above-described individual embodiments, but include various modifications that can be conceived by those skilled in the art, and the effects of the present disclosure are not limited to the above-described contents. In other words, various additions, modifications, and partial deletions may be made without departing from the conceptual idea and spirit of the present disclosure derived from the matters defined in the claims and equivalents thereof.

REFERENCE SIGNS LIST

| | |
|---|---|
| 1 | Imaging device |
| 2 | Pixel array unit |
| 3 | Vertical scanning circuit |
| 4 | Column readout circuit |
| 5 | Column signal processing circuit |
| 6 | Horizontal scanning circuit |
| 7 | Control circuit |
| 8 | DAC |
| 10 | Pixel |
| 11 | Photoelectric conversion element |
| 12 | Transfer transistor |
| 12a | First transfer transistor |
| 12b | Second transfer transistor |
| 13 | Accumulated charge is reset transistor |
| 13 | Reset transistor |
| 14 | Amplifier transistor |
| 15 | Selection transistor |
| 15 | And selection transistor |
| 16 | First substrate |
| 17 | Second substrate |
| 18 | Third substrate |
| 19 | Conversion efficiency switching transistor |
| 21 | Capacitor |
| 22 | Reset potential switch |
| 23 | Illuminance determination unit |
| 24 | Reset potential setting circuit |
| 25 | Voltage source |
| 26 | Switch |
| 27 | Comparator |
| 28 | Charge holding unit |
| 30 | Reference signal generation circuit |
| 31 | Transistor |
| 32 | Transistor |
| 33 | Switch |
| 34 | Current source |
| 35 | Source follower circuit |
| 36 | Switch |
| 37 | Current source |
| 38 | Transistor |
| 39 | Switch |
| 41 | Voltage source |
| 41 | Single voltage source |
| 42 | Potential setting unit |
| 43 | Transistor |

1. An imaging device comprising:
a plurality of pixels arranged in one direction and each including a photoelectric conversion element;
a signal line that transmits a plurality of pixel signals obtained as a result of photoelectric conversion in the plurality of pixels;
an illuminance determination unit that determines illuminance of light incident on the plurality of pixels; and
a reset potential switch that switches a reset potential for initializing a potential of the signal line on a basis of the illuminance determined by the illuminance determination unit.

2. The imaging device according to claim 1, wherein
the illuminance determination unit determines the illuminance in at least two stages.

3. The imaging device according to claim 1, wherein
the illuminance determination unit determines high illuminance or low illuminance, and
the reset potential switch sets the reset potential higher in a case where low illuminance is determined than in a case where high illuminance is determined.

4. The imaging device according to claim 3, wherein
the reset potential switch sets the reset potential in a case where the signal line has a noise potential to be higher than the reset potential in a case where the illuminance determination unit determines low illuminance.

5. The imaging device according to claim 1, further comprising:
a pixel array unit including the plurality of pixels arranged in a first direction and a second direction; and
a plurality of the signal lines, each of which extends in the second direction, is arranged in the first direction, and transmits two or more pixel signals obtained as a result of photoelectric conversion by two or more of the pixels arranged in the second direction, wherein
the illuminance determination unit and the reset potential switch are provided for each of the plurality of signal lines.

6. The imaging device according to claim 1, wherein
the reset potential switch selects, as the reset potential, one of a plurality of input potentials having different potential levels.

7. The imaging device according to claim 6, wherein
the plurality of input potentials includes at least three types of input potentials for setting a noise potential, a reset potential for low illuminance, or a reset potential for high illuminance to the signal line.

8. The imaging device according to claim 1, wherein
each of the plurality of pixels includes a transfer transistor and a floating diffusion, and
before transfer of charge by photoelectric conversion from the photoelectric conversion element to the floating diffusion via the transfer transistor is started, the illuminance determination unit determines the illuminance on a basis of a charge leaking from the photoelectric conversion element to the floating diffusion.

9. The imaging device according to claim 1, wherein
the illuminance determination unit determines the illuminance on a basis of signal potentials of the pixel signals according to an amount of light incident on the plurality of pixels.

10. The imaging device according to claim 9, wherein
the plurality of pixels is capable of switching photoelectric conversion efficiency in at least two stages, and
the illuminance determination unit determines the illuminance on a basis of the signal potentials of the pixel signals in a state where the photoelectric conversion efficiency is maximum.

11. The imaging device according to claim 1, further comprising:
a signal processing unit that performs signal processing including generation of a digital signal according to the potential of the signal line on a basis of a result of comparison between the potential of the signal line and a reference signal, wherein
in a case where the signal line has a noise potential, the reset potential switch sets the reset potential according to the noise potential to the signal line, and then sets the reset potential according to the illuminance determined by the illuminance determination unit to the signal line.

12. The imaging device according to claim 1, wherein
each of the plurality of pixels includes a plurality of the photoelectric conversion elements having different sensitivities, and
the reset potential switch sets the reset potential according to a noise potential to the signal line and reads the noise potential after the illuminance determination unit determines the illuminance, and then sequentially sets the reset potential according to the illuminance determined by the illuminance determination unit to the signal line and reads signal potentials for each of the plurality of photoelectric conversion elements.

13. The imaging device according to claim 1, further comprising:
a reference signal generation circuit that generates a reference signal for setting the signal line to a reference potential, wherein
the illuminance determination unit determines the illuminance on a basis of a potential difference between the potential of the signal line and the reference potential.

14. The imaging device according to claim 1, further comprising:
a constant current source that causes a constant current to flow through the signal line; and
a first switch that connects the constant current source to the signal line only in a case where the signal line is set to a reference potential.

15. The imaging device according to claim 1, wherein
the reset potential switch includes a plurality of reset potential setting circuits connected in parallel between the signal line and a reference potential node, and
each of the plurality of reset potential setting circuits includes:
a voltage source having a different potential level; and
a second switch that switches whether or not to set the potential of the voltage source as the reset potential on a basis of the illuminance determined by the illuminance determination unit.

16. The imaging device according to claim 15, wherein
the illuminance determination unit determines high illuminance or low illuminance, and
in a case where the illuminance determination unit determines low illuminance, the plurality of reset potential setting circuits sets, as the reset potential, the potential of the voltage source having a higher potential level than in a case where the illuminance determination unit determines high illuminance.

17. The imaging device according to claim 1, wherein
the reset potential switch includes a plurality of source follower circuits, a third switch, and a current source connected in series between the signal line and a reference potential node,
each of the plurality of source follower circuits includes:
a transistor having a gate to which a potential of a different potential level is input; and
a fourth switch that switches whether or not to set the signal line to a reset potential according to the potential input to the gate of the transistor,
the third switch is turned on when the signal line is set to a reference potential and causes a constant current to flow through the signal line using the current source, and
after the signal line is set to the reference potential, one of the plurality of fourth switches is turned on on a basis of the illuminance determined by the illuminance determination unit and sets the reset potential of the signal line.

18. The imaging device according to claim 17, wherein
the illuminance determination unit determines high illuminance or low illuminance, and
in a case where the illuminance determination unit determines low illuminance, the plurality of source follower circuits turns on the fourth switch connected to the transistor having the gate to which a higher potential than in a case where the illuminance determination unit determines high illuminance is input and sets the reset potential of the signal line.

19. The imaging device according to claim 1, wherein
the reset potential switch includes a single voltage source connected to the signal line, and a plurality of reset potential setting circuits connected in parallel between the signal line and the voltage source,
each of the plurality of reset potential setting circuits includes a third switch that switches whether or not to select the corresponding reset potential setting circuit, and a potential setting unit connected in series with the third switch, and
the potential setting unit includes a different number of diodes connected in series or diode-connected transistors or connects the third switch to the voltage source.

20. The imaging device according to claim 19, wherein
the illuminance determination unit determines high illuminance or low illuminance, and
in a case where the illuminance determination unit determines low illuminance, the plurality of reset potential setting circuits sets, as the reset potential, the potential of a larger number of diodes connected in series or diode-connected transistors than in a case where the illuminance determination unit determines high illuminance.
